(19) United States
(12) Patent Application Publication
(10) Pub. No.: US 2009/0017345 A1
(43) Pub. Date: Jan. 15, 2009

(54) Molten alkali hydroxide fuel cell

(75) Inventor: Jason C. Ganley, Washington, DC (US)

Correspondence Address: Douglas E. McKinley, Jr., P.O. Box 202, Richland, WA, 99352, US

(73) Assignee: NHThree LLC

(21) Appl. No.: 11/827,577

(22) Filed: Jul. 11, 2007

(51) Int. Cl. H01M 8/14

(52) U.S. Cl. 429/16; 429/41; 429/46

(57) ABSTRACT

A fuel cell having at least one chamber containing a molten alkali hydroxide electrolyte in contact with an anode and a cathode, a fluid pathway allowing hydrogen containing fluids to flow to the anode, and a fluid pathway allowing oxygen containing fluids to flow to the cathode.

### TECHNICAL FIELD

This invention relates to fuel cells. More specifically, this invention relates to fuel cells that can be operated at relatively low temperatures. Additionally, this invention relates to fuel cells utilizing molten alkali hydroxide as an electrolyte, including eutectic mixtures.

### BACKGROUND OF THE INVENTION

There have been a number of examples of fuel cells for converting hydrogen to electricity. Drawbacks of these prior art designs include the relatively high temperatures at which these fuel cells are operated, and the fact that many of these designs require relatively pure, and thus expensive, hydrogen as a fuel source to avoid contamination. As such, these prior art fuel cells cannot be operated using a wide variety of hydrogen containing fuels. Drawbacks of prior art fuel cells also include the use of relatively expensive materials for electrodes and electrolytes. The present invention is designed to overcome these drawbacks.

### SUMMARY OF THE INVENTION

Accordingly, it is an object of the present invention to provide a fuel cell that operates efficiently at temperatures between 200° C. and 750° C. It is a further object of the present invention to provide a fuel cell that uses a highly conductive and very low-cost electrolyte. It is yet a further object of the present invention to provide a fuel cell that uses inexpensive base metal electrocatalysts. It is yet a further object of the present invention to provide a fuel cell that operates using a wide range of fuels. It is yet a further object of the present invention to provide a fuel cell that operates with fast electrode kinetics. It is yet a further object of the present invention to provide a fuel cell that allows for the direct use of ammonia as a fuel, even at temperatures as low as 200° C. It is yet a further object of the present invention to provide a molten alkaline hydroxide electrolyte fuel cell that provides very active intermediate oxygen species within the melt.

These and other objects are accomplished by the present invention which provides a molten alkali hydroxide fuel cell. The fuel cell may be of any number of configurations associated with molten salt type fuel cells, but generally the fuel cell of the present invention will include a chamber containing a molten alkali hydroxide electrolyte in contact with an anode and a cathode, a fluid pathway allowing hydrogen containing fluids to flow to the anode, and a fluid pathway allowing oxygen containing fluids to flow to the cathode.

The present invention is also a method for producing electricity using a molten alkali hydroxide fuel cell. The method of the present invention also generally involves the operation of a fuel cell configured as in any manner normally associated with molten salt type fuel cells, except that the present invention utilizes a molten alkali hydroxide as the electrolyte. Accordingly, the method of the present invention generally involves the steps of providing a chamber containing a molten alkali hydroxide electrolyte in contact with an anode and a cathode, providing hydrogen containing fluids to the anode, and providing oxygen containing fluids to the cathode. In this manner, an electrochemical reaction is promoted wherein the hydrogen from the hydrogen containing fluids are combined with the oxygen from the oxygen containing fluids to form water and generate electricity between the anode and the cathode.

While not meant to be limiting, hydrogen containing fluids include but are not limited to ammonia, hydrogen, hydrazine, methanol, ethanol, formic acid, propane, and combinations thereof. While not meant to be limiting, oxygen containing fluids include but are not limited to oxygen, air, peroxide of hydrogen or other materials, ozone, and combinations thereof.

As will be recognized by those having ordinary skill in the art, and as is typical in fuel cell configurations, it is preferred that the chamber containing a molten alkali hydroxide electrolyte in contact with an anode and a cathode is used in combination with a plurality of additional chambers also containing a molten alkali hydroxide electrolyte in contact with an anode and a cathode. In this manner, a series of fuel cells are used in combination to produce greater currents, voltages, and power. It is also preferred that the molten alkali hydroxide electrolyte is contained within a porous ceramic matrix in the individual cells.

### BRIEF DESCRIPTION OF THE DRAWINGS

The following detailed description of the embodiments of the invention will be more readily understood when taken in conjunction with the following drawings, wherein:

FIG. 1 is a schematic drawing of the molten hydroxide direct ammonia fuel cell used in the proof of principle experiments described herein.

FIG. 2 is a graph showing the polarization behavior of the molten hydroxide direct ammonia fuel cell used in the proof of principle experiments described herein operating at 200° C., 250° C., 300° C., 350° C., 400° C., and 450° C.

FIG. 3 is a graph showing the power production performance of the molten hydroxide direct ammonia fuel cell used in the proof of principle experiments described herein operating at 200° C., 250° C., 300° C., 350° C., 400° C., and 450° C.

### DETAILED DESCRIPTION OF THE PREFERRED EMBODIMENTS

For the purposes of promoting an understanding of the principles of the invention, a series of experiments were conducted reducing the present invention to practice. In these experiments, a direct ammonia fuel cell utilizing a molten alkali hydroxide eutectic melt was fabricated and tested at various operating temperatures between 200° C. and 450° C. The use of a porous nickel anode and a porous cathode of lithiated nickel oxide provided stable cell performance for the duration of the testing. The polarization characteristics of the cell at different operating temperatures indicated that ohmic potential losses dominated the cell performance. A reduction in electrode separation distance and the use of a higher surface area, highly dispersed electrocatalyst at each electrode surface should increase overall cell performance over that shown in these experiments.

Reference will now be made to those experiments, and the embodiments of the present invention used therein. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates. For example, the cell described herein could easily be modified to utilize different geometries, such as, for example, and not meant to be limiting, a more traditional planar fuel cell design, a uniaxial tubular design, and a single chamber design. All such designs utilizing a pure molten alkali hydroxide and/or molten alkali hydroxide mixtures are hereby expressly contemplated by the present invention. Examples include, but are not limited to lithium hydroxide, sodium hydroxide, potassium hydroxide, rubidium hydroxide, and combinations thereof.

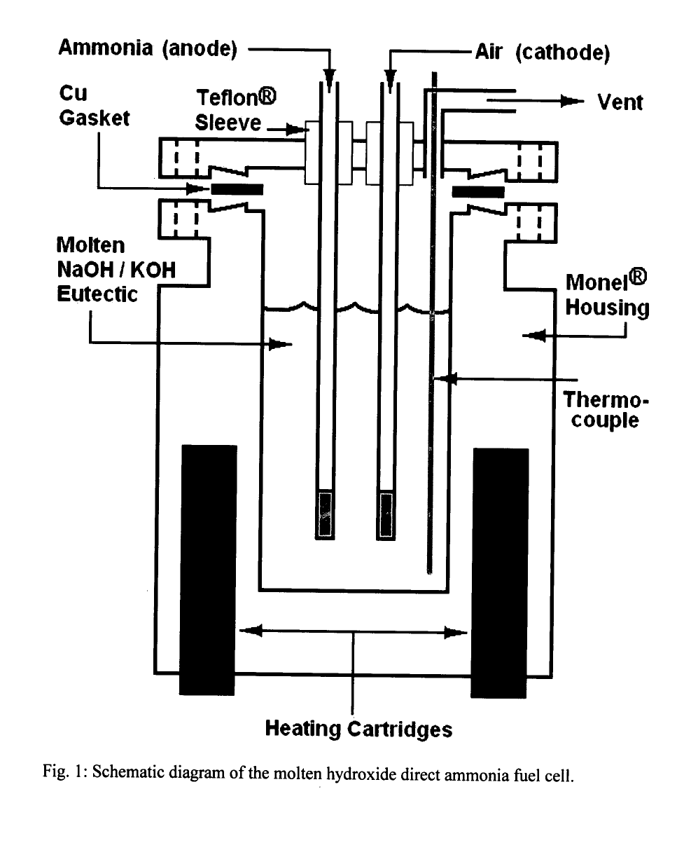

A schematic for the liquid-electrolyte fuel cell used in these experiments is shown in FIG. 1. The cell container was machined from 7 cm diameter Nickel 400 (66.5% Ni, 31.5% Cu, 1.2% Fe, 1.1% Mn) bar stock cut to 15 cm in length. Nickel-400, also known as the commercial Monel® alloy, was chosen due to its resistance to corrosion by molten hydroxides. The bar was internally bored to a depth of 11 cm with a diameter of approximately 3.8 cm. This central well served to store the molten electrolyte. The cell was heated by three 200 W cartridge heaters inserted into holes in the bottom of the container. The top of the cell container was machined with a knife edge and bolt holes to mate with a standard 7 cm stainless steel conflat flange with copper gasket, which served as a cap for the container. The cap provided conduits for fuel and oxidant entry, as well as a combined vent and thermocouple access port.

The anode and cathode electrodes (Mott Corporation) were each 6.4 mm diameter nickel tubes, 18 cm in length, each with a 1.9 cm porous nickel cup (also 6.4 mm in diameter) welded to the end of the tube to create a porous metal sparger at the tube end. The porous spargers had an external superficial surface area of approximately 4 cm², and this area was used for the calculation of the current and power densities produced by the cell. The electrode tubes were isolated from one another and the cell housing by Teflon® tubing sleeves. During cell operation, the electrodes were externally water-cooled to prevent melting the Teflon® sleeves. While immersed in the molten electrolyte, the two porous electrode ends were submerged to a depth of 10 cm and were separated by a lateral center-to-center distance of 2 cm. A direct electrical connection to the cell housing served as a reference electrode. This design proved to be reliable for cell operating temperatures of up to 450° C.

The cell was operated over a range of temperatures from 200 to 450° C. In each experiment, a stream of technical grade (99.99%) anhydrous ammonia was provided to the anode tube at a rate of 15 standard cubic centimeters per minute (sccm), which was automatically regulated by a calibrated mass flow controller. The oxidant provided to the cathode tube was a slight stoichiometric excess (60 sccm) of compressed air at room temperature and approximately 10% relative humidity. The air flow was manually adjusted and was measured with a calibrated mass flow meter. The molten electrolyte for each experiment was a eutectic mixture of sodium and potassium hydroxides (51 mol % NaOH, 49 mol % KOH, Alfa Aesar). This eutectic has the benefit of a much lower melting temperature (170° C.) compared to the melting temperatures of pure sodium and potassium hydroxides (323° C. and 360° C., respectively).

Fuel cell testing was accomplished by measuring the electrical current-potential (polarization) relationship by placing the cell in series with a controlled electronic load (TL5 Test Load, Astris Energi Inc.). The cell was monitored by defining an electric current to be produced by the cell, which the test load resistance was automatically adjusted to allow. The test current was increased from 0 (open circuit) to 200 mA by small steps, and at each prescribed current a resistance-free electrochemical potential measurement was made by interrupting the current for 0.1 ms. These i-V data allowed for the construction of polarization and power production plots.

It was initially determined that a nickel cathode was not optimal for operation within the caustic melt. As is common in molten carbonate fuel cells a nickel cathode quickly oxidized to nickel oxide (NiO), which has very limited electrical conductivity. The oxidation of the cathode could then cause irreversible polarization of the cell and a reduction in the electrochemical potential and consequently the power available from the cell.

This situation is remedied by a number of techniques, including, but not limited to, lithiation of the nickel oxide cathode—doping the nickel with lithium. In this manner, the electrical resistance of the oxide layer is greatly decreased. To produce lithiated nickel oxide from the porous metallic nickel electrode, a thermal-electrochemical treatment procedure was developed. The porous nickel cathode was treated in a 3 M LiOH solution maintained at 100° C. for 24 hours while applying an anodic current of 1 mA/cm². In this single-step treatment, nickel metal is thermally and electrochemically converted first into a hydrated nickel oxide, which is further electrochemically oxidized and lithiated by cationic exchange to produce stoichiometric variants of LiNiO₂. The lithiated nickel sparger is much more stable in the melt and does not polarize or deactivate over time.

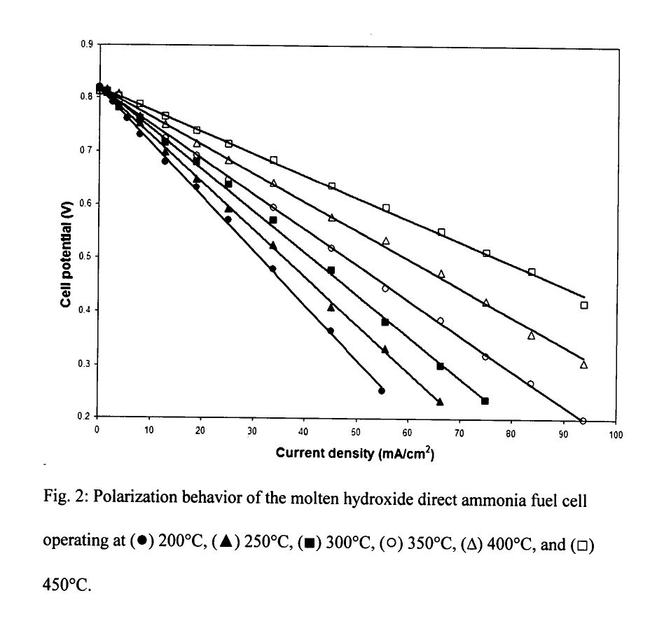

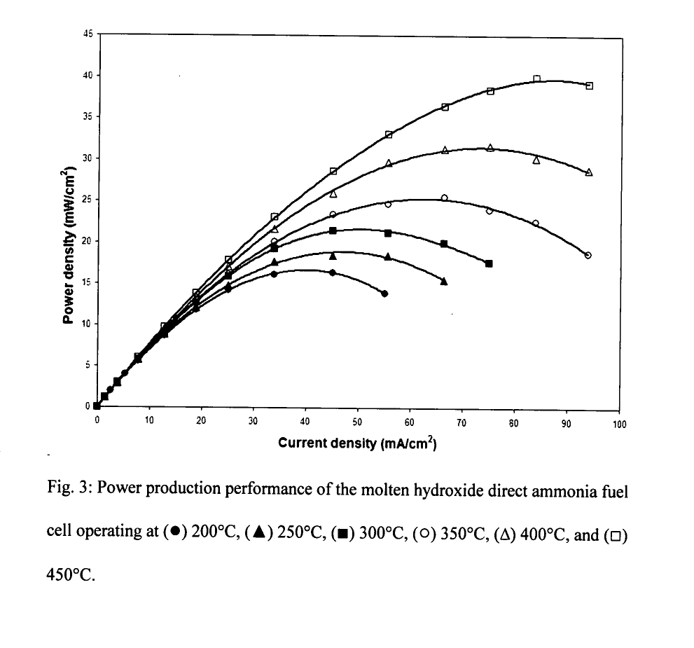

The polarization and power production characteristics of the cell at various temperatures appear in FIGS. 2 and 3, respectively. As the cell operating temperature increased, the open cell potential dropped slightly, which is consistent with the expected cell thermodynamics. Open cell potential at 200° C. was approximately 820 mV, and 811 mV at 450° C. This small thermodynamic potential loss was more than compensated for by the increased conductivity of the electrolyte as temperature increased, leading to less potential loss at higher electrical currents. Consequently, the peak cell performance was achieved at the highest temperature (450° C.), where a power density of approximately 40 mW/cm² was delivered at a current density of approximately 94 mA/cm².

It should be noted that, although the cell used in these proof of principle experiments did not perform at optimal levels, the electrode separation in the liquid electrolyte cell described here (2 cm) is many orders of magnitude greater than that common in current state of the art solid state fuel cells (typically less than 1 mm). Accordingly, as will be recognized by those having ordinary skill in the art, the present invention will perform at more optimal levels by decreasing the distance between the electrodes, as compared to that described in these experiments. This disclosure should be interpreted to encompass all such arrangements.

Given the superior ionic conductivity of the hydroxide melt, isolation of a molten hydroxide eutectic within a thin, inert ceramic matrix tile should greatly reduce ohmic potential losses. It is clear from the linear nature of the data appearing in FIG. 2 that ohmic potential losses are significant for this exemplary system. Additionally, the porous metal spargers are not constructed of a finely divided metal or metal oxide catalyst as is the case in state-of-the-art planar fuel cell stacks. Consequently, the available surface area for reaction and ionization (or product formation) was likely far less may be possible with advanced electrodes. Bubbling the reactant gases through the spargers had the added detriment of consistent blockage of the electrode area from the electrolyte, likely greatly reducing the cell current density. Accordingly, it is preferred that the electrocatalyst have as high a surface area as is possible on a high surface area support. Suitable supports include but are not limited to layers of porous submicron metallic particles, ceramic metal mixtures including fine particles of ceramics, fine particles of metals, and combinations thereof, finely divided catalytic metals on electrically conducting material of more limited catalytic activity.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with an electric device or fluid processing unit, it should be understood to comprehend singular or plural and one or more signal channels or fluid lines as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

I claim:

1. A fuel cell comprising:
a. a chamber containing a molten alkali hydroxide electrolyte in contact with an anode and a cathode,
b. a fluid pathway allowing hydrogen containing fluids to flow to the anode, and
c. a fluid pathway allowing oxygen containing fluids to flow to the cathode.

2. The fuel cell of claim 1 wherein the molten alkali hydroxide electrolyte is selected as lithium hydroxide, sodium hydroxide, potassium hydroxide, rubidium hydroxide, and combinations thereof.

3. The fuel cell of claim 1 wherein the molten alkali hydroxide electrolyte, the anode and the cathode are configured using a planer geometry, a uniaxial tubular geometry, single chamber geometry, and combinations thereof.

4. The fuel cell of claim 1 wherein the anode is selected as layers of porous submicron metallic particles, ceramic metal mixtures including fine particles of ceramics, fine particles of metals, finely divided catalytic metals on electrically conducting material of more limited catalytic activity, and combinations thereof.

5. The fuel cell of claim 1 wherein the cathode is selected as layers of porous submicron metallic particles, ceramic metal mixtures including fine particles of ceramics, fine particles of metals, finely divided catalytic metals on electrically conducting material of more limited catalytic activity, and combinations thereof.

6. The fuel cell of claim 1 wherein the chamber containing a molten alkali hydroxide electrolyte in contact with an anode and a cathode is used in combination with a plurality of additional chambers also containing a molten alkali hydroxide electrolyte in contact with an anode and a cathode.

7. The fuel cell of claim 1 wherein the molten alkali hydroxide electrolyte is contained within a porous ceramic matrix.

8. A method of producing electricity comprising the steps of:
a. providing a chamber containing a molten alkali hydroxide electrolyte in contact with an anode and a cathode,
b. providing hydrogen containing fluids to the anode, and
c. providing oxygen containing fluids to the cathode.

9. The method of claim 8, wherein the hydrogen containing fluids are selected from the group ammonia, hydrogen, hydrazine, methanol, ethanol, formic acid, propane, and combinations thereof.

10. The method of claim 8, wherein the oxygen containing fluids are selected from the group oxygen, air, peroxide of hydrogen or other materials, ozone, and combinations thereof.

11. The method of claim 8 wherein the molten alkali hydroxide electrolyte is selected as lithium hydroxide, sodium hydroxide, potassium hydroxide, rubidium hydroxide, and combinations thereof.

12. The method of claim 8 wherein the molten alkali hydroxide electrolyte, the anode and the cathode are provided in a planer geometry, a uniaxial tubular geometry, single chamber geometry, and combinations thereof.

13. The method of claim 8 wherein the anode is provided as layers of porous submicron metallic particles, ceramic metal mixtures including fine particles of ceramics, fine particles of metals, finely divided catalytic metals on electrically conducting material of more limited catalytic activity, and combinations thereof.

14. The method of claim 8 wherein the cathode is provided as layers of porous submicron metallic particles, ceramic metal mixtures including fine particles of ceramics, fine particles of metals, finely divided catalytic metals on electrically conducting material of more limited catalytic activity, and combinations thereof.

15. The method of claim 8 wherein the chamber containing a molten alkali hydroxide electrolyte in contact with an anode and a cathode is provided in combination with a plurality of additional chambers also containing a molten alkali hydroxide electrolyte in contact with an anode and a cathode.

16. The method of claim 8 wherein the molten alkali hydroxide electrolyte is provided as contained within 1a porous ceramic matrix.
